(19) United States
(12) Patent Application Publication
(10) Pub. No.: US 2025/0390617 A1
(43) Pub. Date: Dec. 25, 2025

(54) SYSTEM AND METHOD FOR CALIBRATING A DIGITAL TWIN

(71) Applicant: Universal City Studios LLC, Universal City, CA (US)

(72) Inventor: Josiah Logan Bender, Winter Park, FL (US)

(21) Appl. No.: 18/747,690

(22) Filed: Jun. 19, 2024

(51) Int. Cl. G06F 30/12; G06F 111/18

(52) U.S. Cl. CPC G06F 30/12; G06F 2111/18

(57) ABSTRACT

A system for calibrating a digital twin includes first and second pucks and a computing device. The first puck is configured to be disposed at a first location and to emit a first signal indicative of a first set of coordinates of the first location. The second puck is configured to be disposed at a second location and to emit a second signal indicative of a second set of coordinates of the second location. The computing device is configured to receive the first set of coordinates of the first location, receive the second set of coordinates of the second location, align a first reference point of the digital twin with the first set of coordinates of the first location, and align a second reference point of the digital twin with the second set of coordinates of the second location.

### BACKGROUND

The present disclosure relates generally to digital twins and, more specifically, calibrating a digital twin to a physical space.

Digital twins are digital representations of physical environments or objects. Accordingly, digital twins can be used to model actual conditions and/or proposed parameters or characteristics of physical environments or objects. However, calibrating digital twins to accurately correspond to physical environments or objects tracked in physical space is tedious, time consuming, and error prone. Accordingly, techniques for making the calibration of digital twins faster, easier, more repeatable, and more accurate are needed.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a system for calibrating a digital twin includes first and second pucks and a computing device. The first puck is configured to be disposed at a first location and to emit a first signal indicative of a first set of coordinates of the first location. The second puck is configured to be disposed at a second location and to emit a second signal indicative of a second set of coordinates of the second location. The computing device includes processing circuitry and memory. The memory is accessible by the processing circuitry and stores instructions that cause the processing circuitry to receive the first set of coordinates of the first location, receive the second set of coordinates of the second location, align a first reference point of the digital twin with the first set of coordinates of the first location, and align a second reference point of the digital twin with the second set of coordinates of the second location.

In an embodiment, a non-transitory computer readable medium stores instructions that, when executed by processing circuitry, cause the processing circuitry to receive a first set of coordinates of a first puck disposed at a first location, receive a second set of coordinates of a second puck disposed at a second location, translate a digital twin to align a first reference point of the digital twin with the first set of coordinates of the first location, adjust a scale factor of the digital twin such that a first distance (e.g., virtual distance) between the first reference point of the digital twin and a second reference point of the digital twin is equal to a second distance (e.g., physical distance) between the first set of coordinates of the first location and the second set of coordinates of the second location, and rotate the digital twin to align the second reference point of the digital twin with the second set of coordinates of the second location.

In an embodiment, a method for calibrating a digital twin includes receiving a first signal indicative of a first set of coordinates of a first puck disposed at a first location, receiving a second signal indicative of a second set of coordinates of a second puck disposed at a second location, translating the digital twin to align a first reference point of the digital twin with the first set of coordinates of the first location, adjusting a scale factor of the digital twin such that a first distance between the first reference point of the digital twin and a second reference point of the digital twin is equal to a second distance between the first set of coordinates of the first location and the second set of coordinates of the second location, rotating the digital twin to align the second reference point of the digital twin with the second set of coordinates of the second location, and operating a digital twin in a digital environment.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustrating a system for calibrating a digital twin operating in a digital environment to a physical development environment, in accordance with an embodiment of the present disclosure;

FIG. 2 is a schematic illustrating the system of FIG. 1 in which two or more pucks communicate directly with a computing device, in accordance with an embodiment of the present disclosure;

FIG. 3 is a schematic illustrating the system of FIG. 1 for calibrating the digital twin operating in the digital environment to the physical environment in an attraction, in accordance with an embodiment of the present disclosure;

FIG. 4 illustrates a block diagram of example components of a computing device that may be used within the physical environments of FIGS. 1-3, in accordance with an embodiment of the present disclosure; and

FIG. 5 is a flow chart illustrating an embodiment of a process for calibrating the digital twin, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments.

Digital twins may be used during the development of amusement park attractions, as well as during the operation of amusement park attractions. In the development context, digital twins may be used to simulate amusement park attractions, or aspects of amusement park attractions, in an open space (e.g., a warehouse) to model attraction runtime behavior, spacing of components, sight lines, movement paths through the attraction, guest experience, and so forth. In the operation context, digital twins may be used to simulate various aspects of the attraction in a digital environment in order to generate effects for guests, such as images projected onto surfaces, displays of virtual reality headsets, mobile devices, screens within the attraction, and so forth. However, calibrating digital twins to accurately correspond to objects tracked in physical space is tedious, time consuming, and error prone. Accordingly, techniques for making the calibration of digital twins faster, easier, more repeatable, and more accurate are needed.

The present disclosure is directed to techniques for calibrating a digital twin operating in a digital environment to correspond to a physical environment. A digital twin is a virtual model of a physical object, system, or process that operates in a digital environment. Digital twins typically run a processor-based devices and may be used for simulation, testing, monitoring, and maintenance of the objects, systems, or processes they model. Digital twins are dynamic in that they update in real time or near real time based on data (e.g., sensor data) collected from the physical object, system, or process they model. In an embodiment, the digital twin may be used to simulate one or more aspects of an amusement park attraction in an empty space (e.g., a warehouse) during development of the amusement park attraction, or to simulate one or more aspects of the amusement park attraction during operation of the amusement park attraction following development. For example, two or more pucks may be placed at reference locations in physical space. The pucks may be configured to transmit a signal indicative of coordinates of their respective locations. The signals may be received by towers and relayed to a computing device, or transmitted by the pucks directly to the computing device. The computing device may run software for calibrating the digital twin operating in the digital environment to the physical environment. Specifically, the computing device may be configured to align a first reference point of the digital twin with the first location of the first puck. In an embodiment, aligning the first reference point of the digital twin with the first location of the first puck may include translating the digital twin (within a model three-dimensional environment, also referred to as a digital environment) in the X, Y, and/or Z direction until the coordinates of the first reference point of the digital twin match the coordinates of the first location of the first puck. Similarly, the computing device may align a second reference point of the digital twin with the second location of the second puck. In an embodiment, aligning the second reference point of the digital twin with the second location of the second puck may include, for example, increasing or decreasing a scale (e.g., a scale factor) of the digital twin until a distance (e.g., a virtual distance in the digital environment, such as a distance in vector space) between the first and second reference points is equal to a distance between the first and second locations. Aligning the second reference point of the digital twin with the second location of the second puck may further include rotating the digital twin about the first reference point until the coordinates of the second reference point of the digital twin match the coordinates of the second location of the second puck. If more than two pucks are being used, coordinates of the additional pucks may be received and compared to additional respective reference points within the digital environment to check the calibration of the digital twin.

After calibration, the digital twin may be operating in the digital environment. For example, a person (e.g., a guest or staff member), may utilize an interface device (e.g., a virtual reality headset, mobile device, etc.) configured to display images of the digital twin operating in the digital environment and cause an update to the images displayed in response to movement of the interface device. Further, the person may utilize a handheld interactive device (e.g., simulating a flashlight, a blaster, a magic sword, a piece of sports equipment, a wand, a steering system for a vehicle, etc.) that facilitates guest interaction with the digital environment. Accordingly, the handheld interactive device may receive inputs from the person interacting with the digital environment and the digital twin may be updated to reflect those interactions.

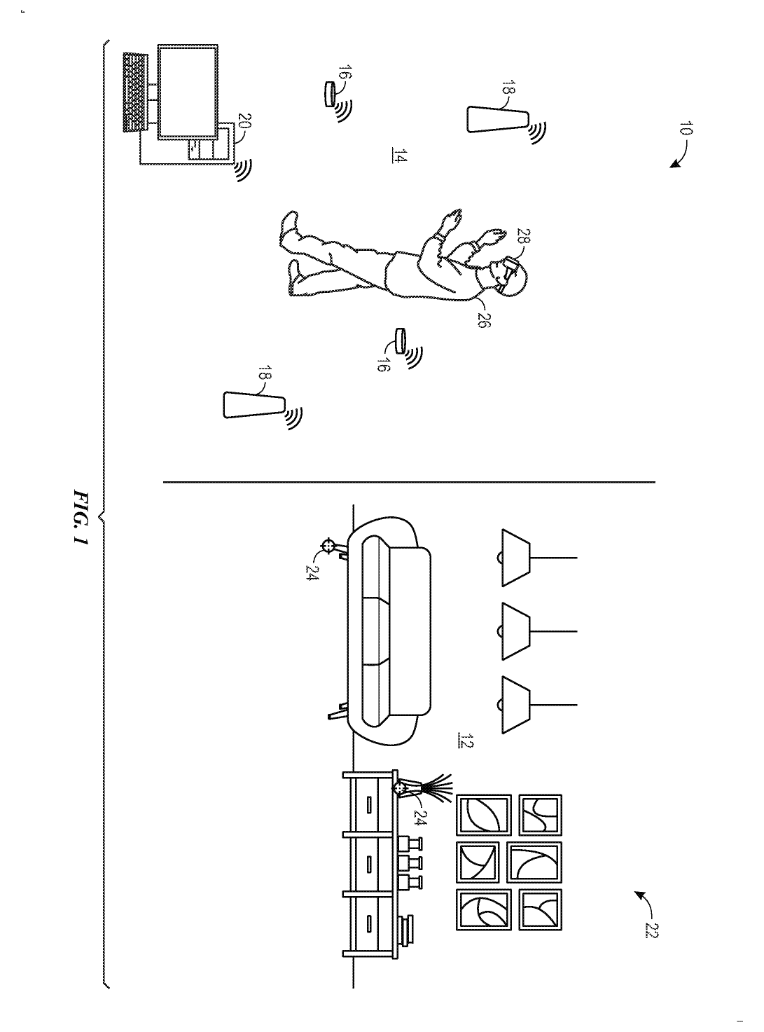

FIG. 1 is a schematic illustrating a system 10 for calibrating a digital twin operating in a digital environment 12 (e.g., a virtual environment instantiated on one or more processors of one or more computing devices) to a physical space 14. Digital twins may be used in development of and/or testing of amusement park attractions. For example, during development of an amusement park attraction, a previously developed digital twin of the attraction may be mapped to a physical space in a warehouse environment in order to test various aspects of the attraction (e.g., spacing of components, sight lines, the feel of a path through the attraction, etc.) prior to building a prototype or mockup of the attraction or parts of the attraction. Further, some attractions may utilize digital twins once the attraction has been built and open to the public. For example, an attraction may include interactive elements, such as a blaster or a flashlight that a person may carry as the person experiences the attraction. At various points during the experience, the person may use the interactive element to interact with the attraction. A digital twin may be used to receive signals from the interactive element and update projections on a surface within the attraction to reflect interactions with the interactive element. However, it is now recognized that calibrating a digital twin with a physical environment can be a tedious and time-consuming process. Accordingly, the system 10 shown in FIG. 1 performs calibrations in a simple, efficient, and accurate manner.

As shown the system 10 includes two or more location-emitting pucks 16, one or more location-receiving towers 18, and a computing device 20. The pucks 16 may be placed at respective reference locations (e.g., points on the floor of a warehouse space) and configured to transmit a signal that indicates the respective location of the puck, as determined by one or more sensors. Because the location of the pucks, and thus the distance between the pucks, affects the scaling and orientation of the digital twin, in some embodiments, the pucks 16 may be placed in or on top of fixed puck holders or receptacles, or placed on/within markings on a surface, such as the floor) to ensure repeatable placement of the pucks 16. Accordingly, the placement of the pucks may be based on a location set by the designer. The signal transmitted by the pucks 16 may indicate the respective cartesian coordinates (e.g., X, Y, Z location) for the location of the puck 16 and/or rotational coordinates of the puck 16 (e.g., quaternion coordinates, roll, pitch, yaw, etc.). The one or more towers 18 may receive the signals transmitted by the pucks 16, triangulate the locations of the pucks 16 and transmits data to the computing device 20. It should be understood that the location of the towers 18 does not affect the calibration of the digital twin, as long as the towers 18 are close enough to the pucks 16 to be able to communicate with the pucks 16. The computing device 20 receives data from the towers 18 and, via a software application running on the computing device 20, renders a digital twin 22 in the digital environment 12, and calibrates the digital twin by matching the locations and/or orientations of the two or more pucks 16 to two or more respective reference points 24 in the digital twin 22. This may include, for example, scaling the digital twin such that the distance (e.g., a virtual distance in the digital environment, such as a distance in vector space) between the reference points 24 matches the physical distance between the pucks 16, translating the digital twin to match the X, Y, Z coordinates of the pucks 16, and/or rotating the digital twin along the X, Y, Z axes (e.g., roll, pitch yaw) to match the pucks 16. If more than two pucks 16 are used, the coordinates of the additional pucks 16 may be compared to other reference points 24 in the digital twin to confirm the calibration (e.g., to confirm that the scaling, rotation, and/or translation are correct). The reference points 24 may be set by a designer of the digital twin (e.g., based on the location of some object within the digital environment 12), or based on the location of puck holders/receptacles in the physical space 14. Accordingly, a person 26 (e.g., a guest, or a person pretending to be a guest) may move about the physical space 14 as though they are in the digital environment 12. In some embodiments, the person 26 may be equipped with a user interface device 28, such as a virtual reality (VR) or augmented reality (AR) headset, mobile device, tablet, etc. configured to display and/or simulate the person’s interactions with the digital environment 12 as the person moves about the physical space 14. For example, as shown in FIG. 1, as the person 26 moves about the physical space 14, the interface device 28 may display a simulation of the person 26 moving about the digital environment 12. For example, the interface device 28 may display to the person 26 items from the digital environment 12, such as the furniture, light fixtures, decorations, and so forth. Accordingly, the interface device 28 may sense changes in its position and/or orientation in the physical space and images displayed by the interface device 28 may be updated based on the position and/or orientation of the interface device 28. Further, if the person moves or otherwise interacts with one or more objects (e.g., turning on lights, moving an object, turning on a TV or computer, etc.), the digital twin 22 may be updated to reflect the changes.

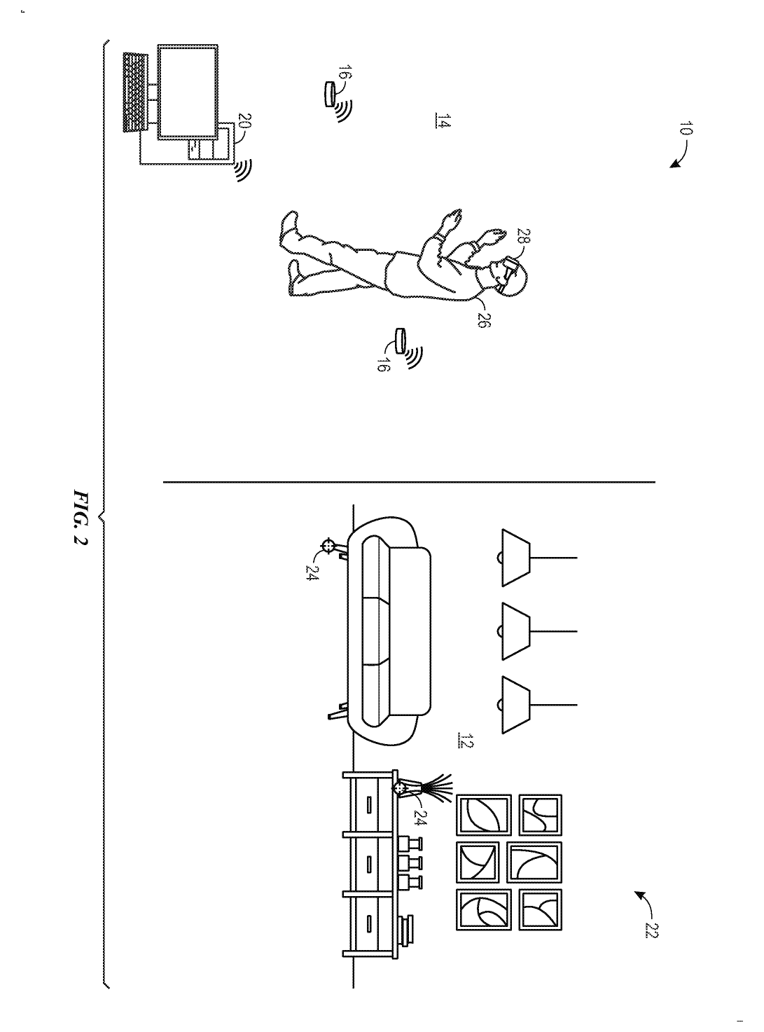

In some embodiments, however, the system 10 may not include towers 18 such that the pucks 16 communicate directly with the computing device 20. FIG. 2 is a schematic illustrating the system 10 of FIG. 1 for calibrating the digital twin operating in the digital environment 12 to the physical space 14 in which two or more pucks 16 communicate directly with the computing device 20. In an embodiment, the pucks 16 are placed at respective reference locations (e.g., points on the floor of a warehouse space) and configured to transmit signals indicative of the respective location of the puck to the computing device 20. The signal transmitted by the pucks 16 may indicate the respective cartesian coordinates for the location of the puck 16 and/or rotational coordinates of the puck 16. The computing device 20 receives the signals transmitted by the pucks 16, triangulates the locations of the pucks 16, renders the digital twin 22 in the digital environment 12, and calibrates the digital twin 22 by matching the locations and/or orientations of the two or more pucks 16 to two or more respective reference points 24 in the digital twin 22 via a software application running on computing device 20. For example, the computing device 20 may be configured to scale the digital twin such that the distance (e.g., in the digital environment) between the reference points 24 matches the distance (e.g., in the physical space) between the pucks 16, translate the digital twin to match the X, Y, Z coordinates of the pucks 16, and/or rotate the digital twin along the X, Y, Z axes (e.g., roll, pitch yaw) to match the coordinates of the pucks 16.

A person 26 (e.g., a guest 26, or a person pretending to be a guest 26), may move about the physical space 14 as though they are in the digital environment 12, as illustrated in FIG. 2. As described above with respect to FIG. 1, the person 26 illustrated in FIG. 2. may be equipped with a user interface device 28, such as a virtual reality (VR) or augmented reality (AR) headset, mobile device, tablet, etc. configured to display and/or simulate the person’s 26 interactions with the digital environment 12 as the person 26 moves about the physical space 14.

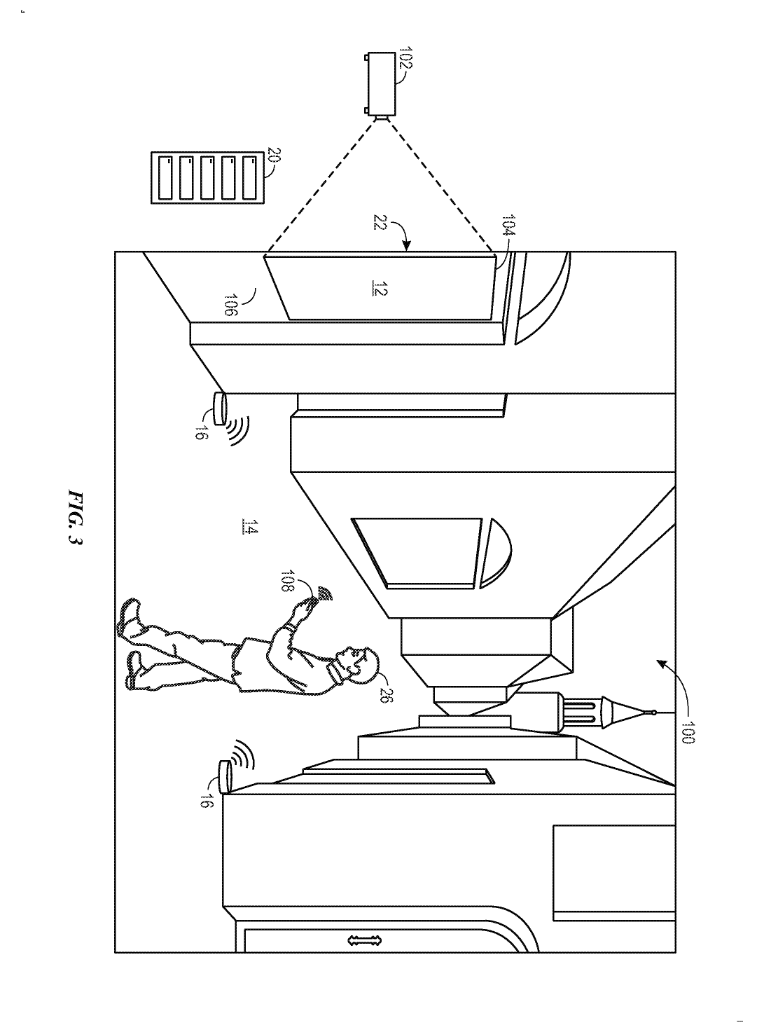

FIG. 3 is a schematic illustrating a system for calibrating a digital twin 22 operating in a digital environment to a physical environment in an attraction 100. As previously discussed, the disclosed techniques may be utilized in an amusement park attraction 100 or other physical space 14 that is open to people, customers, and/or the public. For example, the attraction 100 may include a computing device 20, such as a server, that runs and/or maintains a digital twin 22 operating in a digital environment 12 with which the person 26 may interact as they experience the attraction 100. For example, a projector 102 may project images 104 (e.g., on a surface 106) based on the digital twin 22 that may be visible to the person 26 and with which the person 26 may interact. For example, the person 26 may be equipped with a handheld interactive device 108 such that movement of the handheld interactive device 108 may cause the images 104 projected by the projector 102 on the surface 106 to change in response to the movement of the handheld interactive device 108.

In an embodiment, the handheld interactive device 108 may simulate a flashlight such that the images 104 update based in the position of the handheld interactive device 108 to display a beam of light or to display certain objects in the images 104 as though being illuminated. In an embodiment, the handheld interactive device 108 may simulate a blaster or other device configured to emit lasers, a stream of fluid, projectiles, and so forth, such that when a person 26 pulls a trigger or otherwise activates the handheld interactive device 108, the laser, fluid, projectile, or the like is depicted in the images 104 as though being emitted by the handheld interactive device 108. In an embodiment, the handheld interactive device 108 may simulate a fishing pole, a net, or other equipment for catching/hunting wildlife such that the person 26 may actuate the handheld interactive device 108 and cause the images 104 projected by the projector 102 to update to show the fishing pole, net, or other equipment interacting with wildlife (e.g., catching a fish, etc.). In an embodiment, the handheld interactive device 108 may simulate a magic instrument, such as a wand, magic ball, magic sword, or the like. For example, the person 26 may move the handheld interactive device 108 in specific ways to simulate casting a spell or otherwise causing magic to occur. The images 104 projected by the projector 102 may be updated to represent operation of the spell and/or magic. In an embodiment, the handheld interactive device 108 may simulate a piece of sports equipment, such as a baseball bat, tennis racket, archery bow, hockey stick, lacrosse stick, table tennis paddle, pickleball paddle, or a sports ball. Accordingly, the person 26 may move the handheld interactive device 108 to simulate use of the piece of sports equipment it represents and the images 104 projected by the projector 102 may be configured to update to reflect the sports equipment being used. In an embodiment, the handheld interactive device 108 may simulate a steering wheel or handlebars of a vehicle. The person may move the handheld interactive device 108 to simulate steering a vehicle and the images 104 projected by the projector 102 may update to reflect the steering inputs from the handheld interactive device 108.

In order for the attraction to work properly and create the best effect for the person 26, the digital twin 22 operating in the digital environment 12 may periodically be calibrated to match the physical space 14. Calibration may be performed hourly, at the beginning of each shift, once a day, just before the attraction 100 opens, between each attraction cycle, between a set number of attraction cycles, every other day, once a week, once a month, once a quarter, once a year, when some measured value (e.g., accuracy, deviation from expectation, etc.) falls above or below some threshold value, upon request from an operator, and so forth. During calibration, the two or more pucks 16 may be placed at respective reference locations within the attraction 100 and each configured to transmit a signal that indicates its respective location. The pucks 16 may be placed for calibration and removed when calibration is complete, or the pucks 16 may remain in place during use. The signal transmitted by each of the pucks 16 may indicate the respective cartesian coordinates (e.g., X, Y, Z location) for the location of the respective puck 16 and/or rotational coordinates of the respective puck 16 (e.g., quaternion coordinates, roll, pitch, yaw, etc.). The computing device 20 may receive the signals transmitted by the pucks 16, triangulate the locations of the pucks 16, render the digital twin 22 in the digital environment 12 using the digital twin 22, and calibrate the digital twin 22 by matching the locations and/or orientations of the two or more pucks 16 to two or more respective reference points in the digital twin 22. Calibration may include, for example, scaling the digital twin such that the distance (e.g., in the digital environment) between the reference points matches the distance (e.g., in the physical space) between the pucks 16, translating the digital twin to match the X, Y, Z coordinates of the pucks 16, and/or rotating the digital twin along the X, Y, Z axes (e.g., roll, pitch yaw) to match the pucks 16. In some embodiments, the handheld interactive device 108, or other interface device carried by the person 26, such as a VR or AR headset, mobile device, tablet, etc. is configured to display and/or simulate the person’s interactions with the digital environment 12 as the person 26 moves about the physical space 14.

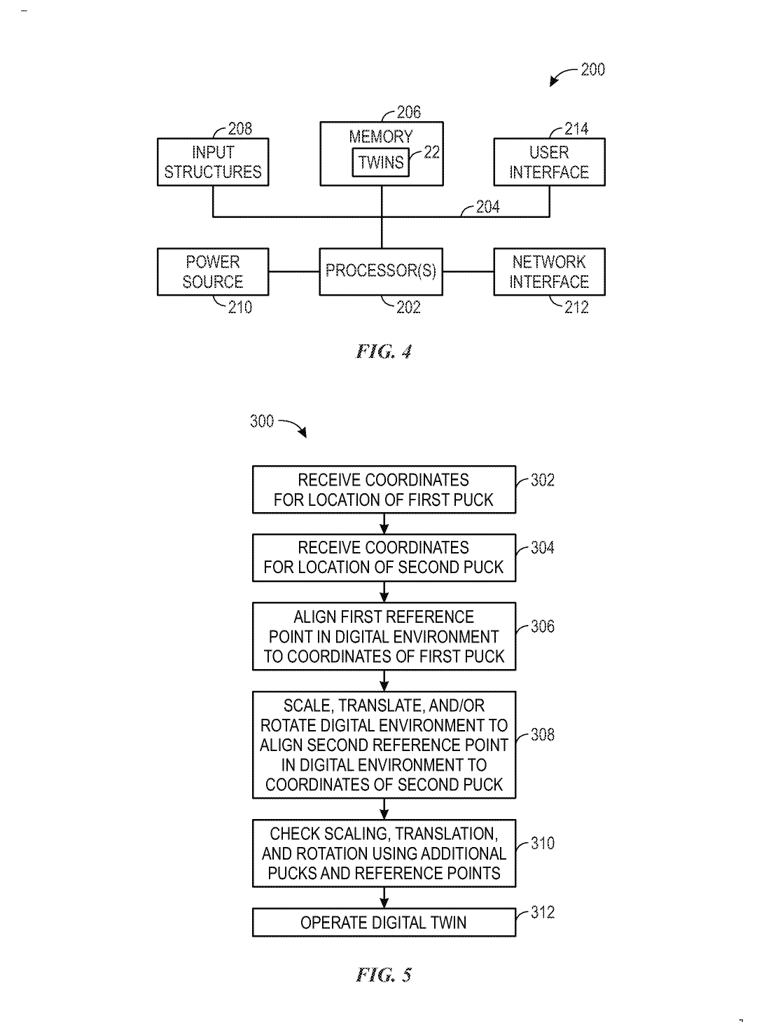

FIG. 4 illustrates a block diagram of example components of a computing device 200 that are configured to be used as the computing device 20, the interface device 28, and interactive device 108, or some other device within the physical spaces shown in FIGS. 1-3. As used herein, a computing device 200 may be implemented as one or more computing systems including laptop, notebook, desktop, tablet, or workstation computers, as well as server-type devices, network devices, such as routers, switches, edge devices, etc., or portable, communication-type devices, such as cellular telephones and/or other suitable computing devices.

As illustrated, the computing device 200 includes various hardware components, such as one or more processors 202, one or more busses 204, memory 206, input structures 208, a power source 210, a network interface 212, a user interface 214, and/or other computer components useful in performing the functions described herein.

The one or more processors 202 (e.g., processing circuitry) may include, in certain implementations, microprocessors configured to execute instructions stored in the memory 206 or other accessible locations. Alternatively, the one or more processors 202 may be implemented as application-specific integrated circuits (ASICs), field-programmable gate arrays (FPGAs), and/or other devices designed to perform functions discussed herein in a dedicated manner. As will be appreciated, multiple processors 202 or processing components may be used to perform functions discussed herein in a distributed or parallel manner.

The memory 206 may encompass any tangible, non-transitory medium for storing data or executable routines. Although shown for convenience as a single block in FIG. 4, the memory 206 may encompass various discrete media in the same or different physical locations. The one or more processors 202 may access data in the memory 206 via one or more busses 204. For example, the memory 206 may store software instructions that may be retrieved and executed by the one or more processors 202. The memory 206 may also store digital twins 22 of models that model or otherwise simulate one or more physical objects or environments in a digital environment, as well as data that may be retrieved and/or processed by the processors using the software instructions and/or AI-based algorithms. In some embodiments, the various components may communicate with one another wirelessly.

The input structures 208 may allow a user to input data and/or commands to the device 200 and may include mice, touchpads, touchscreens, keyboards, controllers, buttons and so forth. The power source 210 can be any suitable source for providing power to the various components of the computing device 200, including line and battery power. In the depicted example, the device 200 includes a network interface 212. Such a network interface 212 may allow communication with other devices on a network using one or more communication protocols. In the depicted example, the device 200 includes a user interface 214, such as a display that may display images or data provided by the one or more processors 202. The user interface 214 may include, for example, a monitor, a display, and so forth. As will be appreciated, in a real-world context a processor-based system, such as the computing device 200 of FIG. 4, may be employed to implement some or all of the present approach, such as performing the functions of the computing device 20, the interface device 28, and the interactive device 108 shown in FIGS. 1-2, as well as other memory-containing devices.

FIG. 5 is a flow chart illustrating an embodiment of a process 300 for calibrating a digital twin. At 302, the process 300 receives coordinates from a first puck or other device configured to be placed at a reference location in a physical environment and output its coordinates. In an embodiment, the data may be received from an intermediary, such as the towers shown and described with regard to FIG. 1, or some other device such as an edge device, a router, a network switch, and so forth. As previously described, the coordinates may include cartesian coordinates (e.g., X, Y, Z location), rotational coordinates of the puck (e.g., quaternion coordinates, roll, pitch, yaw, etc.), other coordinate formats, or some combination thereof. At 304, the process 300 receives coordinates from one or more additional pucks or other devices configured to be placed at reference locations in the physical environment and output coordinates.

At 306, the process 300 aligns or otherwise matches a first reference point in the digital twin to the coordinates of the first puck. For example, the digital twin may be rendered in the digital environment, oriented, translated, etc. such that the coordinates of the digital twin match with the coordinates of the reference location emitted by the puck. In an embodiment, aligning the location of a reference point in the digital twin to the first puck may include modifying the coordinate system of the physical environment, the digital environment, or both to align the origin of the physical environment with the origin of the digital environment.

At 308, the process 300 scales, translates, and/or rotates the digital twin to align a second reference point of the digital twin to the coordinates of the second puck. For example, the digital twin may be expanded or shrunk (e.g., by adjusting a scale factor of the digital twin) such that a distance (e.g., in the digital environment) between the first and second reference points of the digital twin matches the distance between the coordinates of the first and second pucks. In some embodiments, the location of the first reference point of the digital twin may remain fixed in alignment with the coordinates of the first puck while the digital twin is scaled or rotated about the first reference point to bring the second reference point into alignment with the second puck. Further, the digital twin may be translated in the X, Y, and/or Z direction such that the first and second reference points of the digital twin align with the coordinates of the first and second pucks. In some embodiments, the digital twin may be rotated about the first reference point in the roll, pitch, and/or yaw direction such that the first and second reference points of the digital twin align with the coordinates of the first and second pucks.

After the digital twin has been scaled, translated, and/or rotated, the first reference point in the digital environment should be aligned with the location of the first puck and the second reference point of the digital twin should be aligned with the location of the second puck. However, if additional pucks and reference points are being used, location data received from additional pucks may be compared to coordinates for additional corresponding reference points in the digital twin and/or digital environment to check or otherwise confirm the scale, translation, and/or rotation of the digital twin and double check calibration of the digital twin. If the calibration is not confirmed, the process may return to block 302 and repeat the calibration.

At 312, the digital twin may be operated in the digital environment. For example, sensor data may be collected from the physical environment and the digital twin and/or the digital environment updated in response. In some embodiments, updating the digital twin and/or the digital environment may include generating and/or updating images to be displayed via the interface device and/or the interactive device. For example, as previously described, data may be received from interface devices and/or interactive devices that allow people to interact with the digital twin and/or the digital environment. As previously described, the process 300 may return to block 302 and initiate a new calibration based on a calibration schedule, some triggering event, and so forth.

The present disclosure is directed to techniques for calibrating a digital twin operating in a digital environment to correspond to a physical environment. In an embodiment, the digital twin may be used to simulate one or more aspects of an amusement park attraction in an empty space (e.g., a warehouse) during development of the amusement park attraction, or to simulate one or more aspects of the amusement park attraction during operation of the amusement park attraction following development. For example, two or more pucks may be placed at reference locations in physical space. The pucks may be configured to transmit a signal indicative of coordinates of their respective locations. The signals may be received by towers and relayed to a computing device or transmitted by the pucks directly to the computing device. The computing device may run software for calibrating the digital twin operating in the digital environment to the physical environment. Specifically, the computing device may be configured to align a first reference point of the digital twin with the first location of the first puck. In an embodiment, aligning the first reference point of the digital twin with the first location of the first puck may include translating the digital twin in the X, Y, and/or Z direction until the coordinates of the first reference point of the digital twin match the coordinates of the first location of the first puck. The computing device may align a second reference point of the digital twin with the second location of the second puck. In an embodiment, aligning the second reference point of the digital twin with the second location of the second puck may include, for example, increasing or decreasing a scale of the digital twin until a distance between the first and second reference points is equal to a distance between the first and second locations. Aligning the second reference point of the digital twin with the second location of the second puck may further include rotating the digital twin about the first reference point until the coordinates of the second reference point of the digital twin match the coordinates of the second location of the second puck. If more than two pucks are being used, coordinates of the additional pucks may be received and compared to additional respective reference points within the digital twin to check the calibration of the digital twin. After calibration, the digital twin may be operated in the digital environment. For example, person (e.g., a guest, or a person impersonating a guest), may utilize an interface device (e.g., a virtual reality headset, mobile device, etc.) configured to display images of the digital twin and/or the digital environment and update images displayed in response to movement of the interface device. Further, the person may utilize a handheld interactive device (e.g., simulating a flashlight, a blaster, a magic wand, a piece of sports equipment, a steering system for a vehicle, etc.) that facilitates guest interaction with the digital twin and/or the digital environment. Accordingly, the handheld interactive device may receive inputs from the person interacting with the digital twin and/or the digital environment and the digital twin may be updated to reflect those interactions. By utilizing the disclosed techniques, calibration of digital twins may be faster, easier for technicians/operators to perform, more repeatable, and more accurately.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A system for calibrating a digital twin, the system comprising:
a first puck configured to be disposed at a first location and to emit a first signal indicative of a first set of coordinates of the first location;
a second puck configured to be disposed at a second location and to emit a second signal indicative of a second set of coordinates of the second location; and
a computing device, comprising:
processing circuitry; and
memory, accessible by the processing circuitry and storing instructions that, when executed by the processing circuitry, are configured to cause the processing circuitry to perform operations comprising:
receiving the first set of coordinates of the first location;
receiving the second set of coordinates of the second location;
aligning a first reference point of the digital twin with the first set of coordinates of the first location; and
aligning a second reference point of the digital twin with the second set of coordinates of the second location.

2. The system of claim 1, wherein aligning the first reference point of the digital twin with the first set of coordinates of the first location comprises translating the digital twin to align the first reference point of the digital twin with the first set of coordinates of the first location.

3. The system of claim 1, wherein aligning the second reference point of the digital twin with the second set of coordinates of the second location comprises adjusting a scale factor of the digital twin such that a first distance between the first reference point of the digital twin and the second reference point of the digital twin is equal to a second distance between the first location and the second location.

4. The system of claim 1, wherein aligning the second reference point of the digital twin with the second set of coordinates of the second location comprises rotating the digital twin to align the second reference point of the digital twin with the second set of coordinates of the second location.

5. The system of claim 1, comprising: one or more towers configured to:
receive the first and second signals from the first and second pucks; and
transmit, to the computing device, the first set of coordinates of the first location and the second set of coordinates of the second location.

6. The system of claim 1, wherein the computing device is configured to receive the first and second signals directly from the first and second pucks.

7. The system of claim 1, comprising: an interface device configured to display images of a digital environment based on the digital twin.

8. The system of claim 7, wherein the interface device comprises a virtual reality headset.

9. The system of claim 1, wherein the first and second locations are disposed within an amusement park attraction and wherein the digital twin is configured to model one or more characteristics of the amusement park attraction.

10. The system of claim 1, comprising: an interactive device configured to be actuated by a person to enable the person to interact with the digital twin.

11. The system of claim 10, wherein the interactive device represents a flashlight, a blaster, a magic wand, a piece of sports equipment, a steering system for a vehicle, or any combination thereof.

12. The system of claim 10, wherein the interactive device is configured to emit a third signal indicative of inputs to the interactive device, and wherein the computing device is configured to receive the third signal from the interactive device and update the digital twin based on the third signal.

13. A non-transitory computer readable medium storing instructions that, when executed by processing circuitry, cause the processing circuitry to perform operations comprising:
receiving a first set of coordinates of a first puck disposed at a first location;
receiving a second set of coordinates of a second puck disposed at a second location;
translating a digital twin to align a first reference point of the digital twin with the first set of coordinates of the first location;
adjusting a scale factor of the digital twin such that a first distance between the first reference point of the digital twin and a second reference point of the digital twin is equal to a second distance between the first set of coordinates of the first location and the second set of coordinates of the second location; and
rotating the digital twin to align the second reference point of the digital twin with the second set of coordinates of the second location.

14. The non-transitory computer readable medium of claim 13, wherein the first and second sets of coordinates comprise cartesian coordinates.

15. The non-transitory computer readable medium of claim 13, wherein the first and second sets of coordinates comprise quaternion coordinates.

16. The non-transitory computer readable medium of claim 13, wherein the first and second sets of coordinates comprise roll, pitch, and yaw coordinates.

17. The non-transitory computer readable medium of claim 13, wherein the operations comprise operating the digital twin in a digital environment.

18. A method for calibrating a digital twin, comprising:
receiving, from a first puck disposed at a first location, a first signal indicative of a first set of coordinates of the first location;
receiving, from a second puck disposed at a second location, a second signal indicative of a second set of coordinates of the second location;
translating the digital twin to align a first reference point of the digital twin with the first set of coordinates of the first location;
adjusting a scale factor of the digital twin such that a first distance between the first reference point of the digital twin and a second reference point of the digital twin is equal to a second distance between the first set of coordinates of the first location and the second set of coordinates of the second location;
rotating the digital twin to align the second reference point of the digital twin with the second set of coordinates of the second location; and
operating the digital twin in a digital environment.

19. The method of claim 18, comprising:
receiving, from an interface device, a third signal indicative of movement of the interface device; and
updating images displayed by the interface device based on the third signal and the digital twin.

20. The method of claim 18, comprising:
receiving, from an interactive device, a fourth signal indicative of inputs to the interactive device; and
updating the digital twin based on the fourth signal.
